(19) United States
(12) Patent Application Publication
(10) Pub. No.: US 2026/0241364 A1
(43) Pub. Date: Aug. 20, 2026

(54) COLOR-CHANGING PH-INDICATING SILICA GEL AND PREPARATION METHOD THEREOF

(71) Applicant: QINGDAO MEIGAO GROUP CO., LTD., Qingdao (CN)

(72) Inventors: Yongzhao LI, Qingdao (CN); Binjie LI, Qingdao (CN)

(73) Assignee: QINGDAO MEIGAO GROUP CO., LTD., Qingdao (CN)

(21) Appl. No.: 18/992,575

(22) PCT Filed: Aug. 18, 2023
(86) PCT No.: PCT/CN2023/113658

§ 371 Date: Jan. 9, 2025

(30) Foreign Application Priority Data
Aug. 5, 2022 (CN) 202210936482.6

(51) Int. Cl. B01J 20/10; A01K 1/015; B01J 20/02; B01J 20/26; B01J 20/28; B01J 20/30

(52) U.S. Cl. CPC B01J 20/103; A01K 1/0154; A01K 1/0155; B01J 20/0248; B01J 20/262; B01J 20/28004; B01J 20/28047; B01J 20/28057; B01J 20/28069; B01J 20/30; B01J 2220/4806; B01J 2220/49

(57) ABSTRACT

A color-changing pH-indicating silica gel and a preparation method thereof are provided. The method includes the following steps: S1, adding an acidic additive to silica gel particles for soaking, and keeping a PH of the silica gel particles at 3 to 7; S2, collecting wet silica gel particles produced after the treatment in the previous step, dewatering and drying, and grading and screening dried silica gel particles according to a particle size of 0.5 mm to 2 mm to produce a silica gel raw material for dyeing; S3, adding a PH-indicating dye solution to the silica gel particles, and thoroughly mixing, such that the dye solution evenly enters pores of the silica gel and is adsorbed by the silica gel particles to produce color-changing indicating silica gel particles; and S4, mixing the color-changing indicating silica gel particles and an untreated raw material silica gel with a low moisture content.

### CROSS REFERENCE TO THE RELATED APPLICATIONS

This application is the national phase entry of International Application No. PCT/CN2023/113658, filed on Aug. 18, 2023, which is based upon and claims priority to Chinese Patent Application No. 202210936482.6, filed on Aug. 5, 2022, the entire contents of which are incorporated herein by reference.

### TECHNICAL FIELD

The present disclosure relates to the technical field of PH-indicating silica gels, and in particular to a color-changing pH-indicating silica gel and a preparation method thereof.

### BACKGROUND

Silica gel is a highly active adsorption material with rich microporous structures. A pore volume of silica gel is improved usually with an alkaline additive, such that the silica gel can absorb water 1.5 times to 2 times heavier than the silica gel itself. Therefore, silica gel is widely used for the drying and dewatering in various industries and fields. Especially in the field of pet litter, because silica gel is non-toxic and odorless itself, exhibits no toxic and side effects for pets, and can absorb and lock the odor produced by the excrement of pets, silica gel is regarded as one of the preferred materials for pet litter by more and more pet owners. Due to the wide application of silica gel in the field of pet litter, pet owners have put forward increasing needs for the service performance of litter with the increasing concern of pet owners to pet health problems. In addition to the basic function of absorbing the excrement and locking the odor, silica gel is expected to indicate a health status of a pet, which facilitates the monitoring of the health status of the pet.

As one type of pet litter, cat litter is a pet item with very large consumption both inside and outside China, resulting in a large market demand. Currently, there are various types of cat litter. Because silica gel is non-toxic and odorless itself, exhibits no toxic and side effects, and can adsorb the odor of excrement, silica gel has become one of the preferred materials for cat litter. According to the studies of animal research institutes inside and outside China, the normal urine for cats is weakly acidic, and has a pH of 5.5 to 7.5. In the urine with high pH, magnesium-containing crystals are easily produced. In the urine with low pH, calcium-containing crystals are easily produced. Therefore, a health status of a cat can be predicted by testing a pH of the cat urine.

However, the vast majority of the current cat litter products are basic cat litter and rarely have additional functions. A small number of health-indicating cat litter products that has been developed exhibit performance far from meeting the actual customer requirements. For example, the patent CN200910019434.5 applied by the applicants early discloses a cat urine PH-indicating material and a preparation method thereof. This material adopts bromothymol blue and methyl red as indicators. When the urine of a pet makes this material turn red or blue, it indicates that there is a problem with the health of the pet. In this way, this material plays the role of indicating a health status of a cat. However, a production process of the cat urine PH-indicating material in the above patent is relatively traditional, and involves steps such as dye pH regulation, soaking and dyeing, and oven-drying. Because a dye adopted is an alkali-soluble dye and silica gel as a dye carrier is also alkaline (because the silica gel is pore-expanded with an alkaline pore-expanding additive such as ammonia water in advance), a large amount of acid needs to be added for adjusting during the dyeing process to allow an apparent color conforming to the normal pH of cat urine. The addition of acid is easy to cause the precipitation of the dye and also leads to a dye waste liquid during a soaking process, and the waste liquid needs to be discharged. Because the dye is not resistant to high temperatures, the dye is easy to lose due to volatilization during an oven-drying process, resulting in the waste of dye. Moreover, the alkaline pore-expanding additives have strong volatility, which will destroy some inner pores of silica. The alkaline additive with different residues in pores of silica gel particles will affect the coloring effect and the appearance uniformity of silica gel during a dyeing process. An ammonia vapor generated during the oven-drying will corrode the production equipment. The discharge water is also at a risk of including excessive ammonia nitrogen.

Therefore, the existing PH-indicating silica gel process needs to be further optimized.

### SUMMARY

In view of the problems such as high cost, cumbersome steps, and uneven dyeing and low quality of a prepared PH-indicating silica gel in the existing preparation method for PH-indicating silica gels, the present disclosure provides an energy-saving preparation method of a color-changing PH-indicating silica gel. The preparation method can improve the coloring uniformity of silica gel particles, reduce the energy consumption, improve the production efficiency, and reduce the ammonia nitrogen content of discharge water from silica gel raw material production, which is conducive to the environmental protection.

To solve the above problems, the present disclosure provides the following technical solutions:

The present disclosure provides a preparation method of a color-changing pH-indicating silica gel, including the following steps:

S1, Adding an acidic additive to raw material silica gel particles for soaking, and keeping a PH of the silica gel particles at 3 to 7. The acidic additive plays a pore-expanding role. Preferably, the raw material silica gel is washed with water for desalination.

Preferably, in the S1, the acidic additive is selected from one or more of aluminum nitrate, aluminum sulfate, and potassium aluminum sulfate.

As pet litter, silica gel cat litter has a pore volume generally larger than 0.7 mL/g. In order to allow the pore-expanding during a production process, a low-priced alkaline material such as ammonia water, ammonium sulfate, or ammonium carbonate is generally adopted as an additive, which has a pH of 6 to 8 and has a pore-expanding mechanism of reducing a surface tension for pores of wet silica gel during an oven-drying and dewatering process. However, the alkaline additive has strong volatility, which will destroy some inner pores of silica. An ammonia vapor generated during the oven-drying will corrode the production equipment. The discharge water is also at a risk of including excessive ammonia nitrogen. The alkaline additive with different residues in pores will affect the coloring effect and the appearance uniformity during a dyeing process. A large amount of an acid needs to be added for neutralization during a dyeing process to make a pH of chromogenic particles reach the normal pH range of cat urine. Therefore, the present application adopts an acidic additive such as aluminum nitrate, aluminum sulfate, and potassium aluminum sulfate instead as a breakthrough. Through the silicon-aluminum coordination, such an additive enables pores of silica gel to not collapse during an oven-drying process. In addition, the additive is not easy to volatilize in pores, which avoids the risk of corrosion to production equipment resulting from volatilization. Experiments have proved that the coloring uniformity of indicating silica gel product particles produced with such an acidic additive is greatly improved, and silica gel particles undergoing pore expansion with the acidic additive are acidic, which allows the omitting of an acid-addition step in the subsequent dyeing process and thus reduces the consumption and use of an acid. The dye can be directly used for coloring after being prepared, and the direct spray-coating does not involve the discharge of a waste liquid, which reduces the energy consumption, improves the production efficiency, reduces the ammonia nitrogen content in discharge water from the silica gel raw material production, and is conducive to the environmental protection.

Optionally, in the S1, the soaking in the acidic additive is conducted under the following conditions: a soaking temperature: 20° C. to 90° C., a soaking time: 3 h to 24 h, and a soaking concentration: 0.01% to 1%.

S2, Collecting wet silica gel particles produced after the treatment in the previous step, dewatering and drying, and grading and screening dried silica gel particles according to a particle size of 0.5 mm to 2 mm to produce a silica gel raw material for dyeing.

Preferably, in the S2, the dewatering and drying is conducted at 80° C. to 150° C. for 4 h to 36 h.

S3, Adding a PH-indicating dye solution to the silica gel particles, and thoroughly mixing, such that the dye solution evenly enters pores of the silica gel and is adsorbed by the silica gel particles to produce dyed silica gel particles with a moisture content kept at 15% to 50%, which are color-changing indicating silica gel particles.

Indicators adopted in the PH-indicating dye solution include, but are not limited to, methyl red and bromothymol blue, and also include other dyes capable of playing an acid-base color change indicating role, such as methyl orange, methyl violet, methyl yellow, Congo red, bromocresol green, neutral red, phenol red, ethoxychrysoidine hydrochloride, thymol blue, phenolphthalein, bromophenol blue, cresol red, thymolphthalein, quinaldine red, catechol violet, litmus, m-cresol purple, and α-naphtholbenzein.

Optionally, in the S3, a preparation method of the PH-indicating dye solution is as follows: mixing a dye A and a dye B according to a weight ratio of 1/100 to 1/2, and dissolving in an alkaline solution with a dye mass percentage concentration of 0.05% to 1%; and adding a dispersion additive with a volume percentage concentration of 5% to 50%, and thoroughly stirring to produce the PH-indicating dye solution.

The dye A is methyl orange, bromocresol green, ethoxychrysoidine hydrochloride, methyl red, thymol blue, or quinaldine red; and the dye B is catechol violet, litmus, bromothymol blue, m-cresol purple, or α-naphtholbenzein.

Preferably, a mass ratio of the dye B to the dye A is 16:1. Experiments have proved that, at this ratio, the indicating silica gel exhibits the optimal indication effect and has high sensitivity to color change.

Preferably, the dispersion additive is polyethylene glycol or polyvinylpyrrolidone. Due to a different physical structure from sawdust, bentonite, etc., silica gel has the characteristics of a high-water absorption rate and a large absorption capacity. If silica gel is used by the conventional method, the color development of a PH indicator on a surface of the silica gel is not obvious. In the present application, a water-soluble dispersant is added to increase the dispersion of a pH indicator in an aqueous solution, such that the indicator can be evenly loaded on the silica gel to react with pet urine for color development. Experiments have proved that, among a variety of different dispersion additives, polyethylene glycol and polyvinylpyrrolidone exhibit the optimal dispersion effect for an indicator and can improve the dispersion uniformity of an indicator on silica gel and the sensitivity of color development of an indicator loaded on silica gel when encountering a solution. The use of polyethylene glycol as the dispersant is conducive to reducing a manufacturing cost. Therefore, polyethylene glycol is preferably adopted as the dispersant.

Experiments have proved that, when a mass percentage of the dispersant is 5% or more, the performance requirements of the product can be met. Optionally, a concentration of the dispersant is 5% to 20%. Most preferably, a mass percentage concentration of the dispersant is controlled at 5%, which minimizes a cost of the dispersant.

In order to find the optimal order of adding the dispersant, the applicants have found through experiments that: If the indicator is added first and then the dispersant is added, the indicator will enter an inside of the silica gel, and the silica gel will be wrapped outside by the dispersant, resulting in slow color development when the silica gel encounters a solution. However, if the dispersant is added first and then the indicator is added or the two are first pre-mixed and then used for silica gel impregnation, it is conducive to the full contact of an indicator molecule with a solution, and the color development is fast. Given both the process simplification and the easy control, preferably, the indicator and the dispersant are premixed first and then used to soak or spray-dye the silica gel to prepare the color-changing pH-indicating silica gel.

Optionally, in the S3, an excessive dye solution on silica gel particles is removed through centrifugation. This method can quickly remove the excessive liquid from dyed silica gel, which is conducive to the subsequent step.

S4, Thoroughly mixing the color-changing indicating silica gel particles and an untreated raw material silica gel with a low moisture content, such that the two silica gels are in full contact. This step is intended to absorb the volatile water in the color-changing indicating particles based on the adsorption characteristic of the raw material silica gel, so as to achieve the purpose of removing the water in the color-changing indicating silica gel particles.

Because the color-changing indicating dye is generally an organic weak acid or weak base, a change of a molecular structure in a proton transfer process causes a color change of the dye itself, and the color change with the structure is reversible. However, the dye is easily denatured under long-term high-temperature conditions, and an indicator solution prepared with the dye has a shelf life generally of 1 month to 2 months and exhibits sensitivity easy to decrease beyond the shelf life. In a production process of a dye manufacturer, a dye is oven-dried usually at a temperature lower than 70° C. and then sold. In the traditional dyeing process for a color-changing indicating silica gel, a dye powder oven-dried by a dye manufacturer needs to be prepared into a homogeneous solution and then used to impregnate pores of silica gel, and then the water in the pores is removed through external high-temperature oven-drying. Due to the porous structure and the thermal insulation characteristic of the silica gel itself, heating rates inside and outside the particles is inconsistent during an oven-drying process. An insufficient inside temperature often leads to the failed oven-dying, and a too-high outside temperature leads to the failure of a dye, resulting in the energy waste and the dye loss.

Based on the recognition of importance of the above problems, in order to avoid the drawbacks brought by the conventional heat-drying method, the present disclosure makes full use of the water-absorption and drying characteristic of silica gel to fully absorb the residual water in the dyed particles using a white silica gel without a dye, which fully protects the dye in pores, makes the color change sensitive, and saves the energy consumption for oven-drying.

Preferably, the moisture content of the raw material silica gel is 0.5% to 5%, and a mixing mass ratio of the color-changing indicating silica gel particles to the raw material silica gel with the low moisture content is 5% to 30%; and a treating time is 12 h to 48 h. When the mass ratio of the color-changing indicating silica gel particles to the raw material silica gel is less than 5%, the color-changing pH-indicating silica gel does not undergo significant color development. When the mass ratio of the color-changing indicating silica gel particles to the raw material silica gel is higher than 30%, the water in the color-changing indicating silica gel is not easily absorbed fully, and a processing efficiency is low.

Preferably, the raw material silica gel particles have a particle size of 0.5 mm to 4 mm, a pore volume of 0.7 mL/g to 1.1 mL/g, and a specific surface area of 300 m²/g to 600 m²/g. Experiments have proved that the raw material silica gel with this specification enables a uniform dyeing effect and a prominent peculiar smell-absorbing effect.

According to the color development mechanism and performance of an indicator, the preparation method of the present application simplifies a production process of the color-changing pH-indicating silica gel and reduces the energy consumption and material consumption by changing an additive type and coloring and drying modes for a raw material silica gel.

In another aspect, the present disclosure also provides a color-changing pH-indicating silica gel prepared by the method above.

The preparation method of the color-changing pH-indicating silica gel provided in the present disclosure has the following beneficial effects:

1. In the present application, a raw material silica gel is subjected to pore expansion with an acidic additive such as aluminum nitrate, aluminum sulfate, and potassium aluminum sulfate instead of the conventional alkaline additive. Through the silicon-aluminum coordination, pores of the silica gel will not collapse during an oven-drying process. The acidic additive is not easy to volatilize in pores, which avoids the risk of corrosion to production equipment. The coloring uniformity of silica gel product particles produced accordingly is greatly improved. As a result, both a role of protecting pores and a role of pre-adjusting a pH are played, and there is no need to add an acid to the PH-indicating dye, which avoids the precipitation of an alkaline dye, makes a dye solution fully and evenly absorbed by silica gel, and does not involve the discharge of a waste liquid.

2. By mixing a dyed high-moisture-content silica gel directly with a low-moisture-content raw material silica gel, a water absorption and drying effect of the silica gel itself makes the water in the dyed particles fully absorbed, which does not require the heat-drying, reduces the energy consumption, and prevents the volatilization and waste of a dye due to temperature intolerance.

In summary, the preparation method of the color-changing PH-indicating silica gel provided in the present application simplifies the operation steps, saves the consumption of an acid, reduces the energy consumption, improves the production efficiency, reduces the ammonia nitrogen content in discharge water from silica gel raw material production, and is conducive to the environmental protection. In addition, the indicating silica gel prepared by the method undergoes uniform dyeing and has high detection sensitivity.

### BRIEF DESCRIPTION OF THE DRAWINGS

FIGS. 1A-1B show a comparison diagram of flow charts of the preparation method of a color-changing pH-indicating silica gel in the present disclosure and the existing method, where FIG. 1A shows the existing preparation method of a color-changing pH-indicating silica gel and FIG. 1B shows the preparation method of a color-changing pH-indicating silica gel in the present disclosure.

### DETAILED DESCRIPTION OF THE EMBODIMENTS

The technical solutions of the embodiments of the present disclosure are clearly and completely described below with reference to the accompanying drawings in the embodiments of the present disclosure. Apparently, the embodiments are merely some rather than all of the embodiments of the present disclosure. All other embodiments obtained by those skilled in the art based on the embodiments of the present disclosure without creative efforts should fall within the protection scope of the present disclosure. In the present disclosure, unless otherwise specified, all devices and raw materials used are commercially available or are commonly used in the art. All methods in the following embodiments are conventional methods in the art, unless otherwise specified.

### Example 1 Improvement of a Pore-Expanding Additive for Silica Gel

### 1. Experimental Method

In this example, an experimental group and a control group were set, and pore volumes of silica gel particles were unified to 0.8 mL/g to 1.2 mL/g. An acidic pore-expanding additive adopted in the experimental group was one or a combination of aluminum nitrate, aluminum sulfate, and potassium aluminum sulfate, and an alkaline pore-expanding additive adopted in the control group was one or a combination of ammonia water, sodium hydroxide, sodium carbonate, sodium bicarbonate, and sodium acetate. In this example, methyl orange and thymol blue were taken as a dye for example. The dye could be replaced by other types, which had little influence on the results of this example.

Specific experimental steps were as follows:

(1) Experimental group: The acidic additive was dissolved and diluted with water to process addition amounts: 0.05%, 0.1%, 0.3%, and 0.5%. A wet silica gel was soaked for 6 h, then oven-dried at 100° C. until a moisture content was lower than 10%, crushed, and sieved to produce particles with a particle size of less than 2 mm. A prepared dye solution was spray-coated on silica gel particles evenly to produce chromogenic indicating particles.

(2) Control group: The alkaline additive was dissolved and diluted with water to process addition amounts: 0.05%, 0.1%, 0.3%, and 0.5%. A wet silica gel was soaked for 6 h, then oven-dried at 100° C. until a moisture content was lower than 10%, crushed, and sieved to produce particles with a particle size of less than 2 mm. A pH of a dye solution was adjusted according to a pH of the silica gel particles. An overall mass percentage concentration of the dye solution was 0.5%, and a mass ratio of the methyl orange to the thymol blue was 1:57. Dyeing was conducted by soaking for 6 h. Colored particles were taken out and oven-dried at 75° C. for 9 h to produce chromogenic indicating particles. A residual liquid produced after silica gel dyeing was stored separately.

### 2. Detection Method

(1) Method for calculating and determining a precipitation rate of an alkali-soluble dye: Concentrations of a dye solution before and after pH adjustment were determined by an inductively coupled plasma-mass spectrometry (ICP-MS) instrument, and a precipitation rate was calculated according to a concentration difference.

(2) Calculation of an amount of an acid added to adjust a pH of each ton of a dye solution: The calculation was conducted according to a pH (1) of silica gel particles and a pH (2) of chromogenic appearance: m (sulfuric acid)=volume of a dye solution*49*10^{(pH(1)-2*pH (2))}.

(3) Detection method of a color difference of silica gel particles: Color difference meter.

### 3. Experimental Results and Analysis

According to the results in Table 1: In the control group, an amount of an acid added to adjust a pH of each ton of a dye solution reached 52.6 g to 461 g, a precipitation rate of the alkali-soluble dye was 5.6% to 18.8%, and a color difference of dyed silica gel was 2% to 11%. In the experimental group, the acid addition was omitted, the problem of alkali-soluble dye precipitation was avoided, the silica gel dyeing was uniform, and a color difference was 0.5% to 1% and could reach a minimum of 0.5%.

Apparently, compared with the control group, the experimental group adopting the acidic pore-expanding additive of the present application simplifies the method of the color-changing PH-indicating silica gel, greatly saves the consumption and use of the acid, reduces the energy consumption, improves the production efficiency, avoids the environmental pollution caused by the compatible dye precipitation, and is eco-friendly.

TABLE 1
Experimental results of the improvement of a pore-expanding additive for silica gel

| | | | | | Amount of an | | |
|---|---|---|---|---|---|---|---|
| | | | | | acid added to | | Color |
| | | | | | adjust a pH of | Precipitation | difference |
| | Pore- | | pH of | Pore | each ton of a | rate of an | of dyed |
| | expanding | Addition | silica gel | volume, | dye solution, | alkali-soluble | silica gel |
| | agent | amount | particles | mL/g | g/t | dye | particles |
| Control | Sodium | 0.05% | 6.1 | 0.81 | 52.6 | 5.6% | 2% |
| group 1 | carbonate | | | | | | |
| Control | Sodium | 0.1% | 6.9 | 0.93 | 168 | 9.1% | 5% |
| group 2 | acetate | | | | | | |
| Control | Sodium | 0.3% | 7.3 | 1.15 | 325 | 15.4% | 8% |
| group 3 | hydroxide | | | | | | |
| Control | Ammonia | 0.5% | 7.8 | 1.09 | 461 | 18.8% | 11% |
| group 4 | water | | | | | | |
| Experimental | Potassium | 0.05% | 6.0 | 0.82 | 0 | 0 | 1% |
| group 1 | aluminum | | | | | | |
| | sulfate | | | | | | |
| Experimental | Aluminum | 0.1% | 5.2 | 1.13 | 0 | 0 | 0.5% |
| group 2 | nitrate | | | | | | |
| Experimental | Aluminum | 0.3% | 4.3 | 0.97 | 0 | 0 | 0.8% |
| group 3 | sulfate | | | | | | |

### Example 2 Improvement of a Drying Method for Dyed Silica Gel Particles

Due to the low temperature stability of a dye, the dye is easily lost during a high-temperature treatment. However, due to the porous structure and the thermal insulation characteristic of silica gel itself, heating rates inside and outside silica gel particles is inconsistent during an oven-drying process. An insufficient inside temperature often leads to the failed oven-dying, or a too-high outside temperature leads to the failure of a dye, resulting in the energy waste and the dye loss.

In the experimental group set in this example, based on the water absorption and drying characteristic of silica gel itself, an excessive dye solution is removed through centrifugation, and then the ordinary raw material silica gel particles are mixed with dyed silica gel particles produced after the centrifugation, such that the dye solution in the dyed silica gel is gradually absorbed into the raw material silica gel particles, thereby achieving the purpose of reducing a moisture content in the dyed silica gel particles. This drying method involves simple operations and mild conditions and does not destroy an activity of the dye.

1. Experimental raw materials: A dye A was methyl orange, bromocresol green, ethoxychrysoidine hydrochloride, methyl red, thymol blue, or quinaldine red. A dye B was catechol violet, litmus, bromothymol blue, m-cresol purple, or α-naphtholbenzein. Because experiments had proved that the use of the above different dyes in combination led to consistent experimental results, in the following specific examples, methyl red was taken as the dye A and bromothymol blue was taken as the dye B, for example.

Dyed high-moisture-content silica gel particles: which had a moisture content of 25% to 50%.

Low-moisture-content silica gel particles: A moisture content in the raw material silica gel was 0.5% to 5%.

### 2. Specific Experimental Method

(1) Control groups: A plurality of groups of dyed high-moisture-content silica gel particles were oven-dried in 50° C., 60° C., 70° C., and 80° C. ovens for 8 h to 48 h, respectively.

(2) Experimental groups: Dyed high-moisture-content silica gel particles were mixed with low-moisture-content silica gel particles according to mass ratios of 5%, 12%, 17%, and 28%.

A detection method was as follows: A content of a dye component in silica gel chromogenic particles was determined by an ICP-MS instrument.

### 2. Experimental Results and Analysis

TABLE 2
Detection results for PH-indicating silica gels produced by different drying methods

| | | Mass ratio of high-moisture-content | Concentration | Concentration |
|---|---|---|---|---|
| | | chromogenic particles to low-moisture- | of the dye | of the |
| | Group | content silica gel particles | A (ppm) | dye B (ppm) |
| Experimental | 1 | 5% | 68 | 255 |
| groups | 2 | 12% | 85 | 412 |
| | 3 | 17% | 164 | 863 |
| | 4 | 28% | 151 | 714 |
| | | | Concentration | Concentration |
| | | | of the | of the |
| | Group | Oven-drying temperature | dye A (ppm) | dye B (ppm) |
| Control | 1 | 50° C. | 62 | 664 |
| groups | 2 | 60° C. | 49 | 503 |
| | 3 | 70° C. | 33 | 258 |
| | 4 | 80° C. | 21 | 135 |

According to the results in Table 2: In the control groups, a content of the dye A was in a range of 21 ppm to 62 ppm and a content of the dye B was in a range of 135 ppm to 664 ppm in a dried dyed silica gel. In the experimental groups, a content of the dye A was in a range of 68 ppm to 164 ppm and a content of the dye B was in a range of 255 ppm to 863 ppm in a dried dyed silica gel.

It can be seen that a content of the remaining dye in a silica gel component of an experimental group adopting the centrifugation and silica gel absorption drying method is much higher than a corresponding content of the control group, indicating that the method can fully protect the dye in pores of silica gel and avoid the destruction due to a high temperature treatment. Therefore, the color-changing PH-indicating silica gel undergoes sensitive color change, and the energy consumption caused by oven-drying is also saved.

### Example 3 Optimization of a Dispersant Concentration

### 1. Experimental Method

In this example, 5 experimental groups were set, where the different dispersant concentrations in Table 3 were adopted, respectively. Polyethylene glycol was adopted as a dispersant (polyethylene glycol with molecular weights of 200/400/600 exhibited comparable effects, and polyethylene glycol with a molecular weight of 400 was adopted for example in this example).

According to the respective weight percentages, 2%, 5%, 8%, 11%, and 14% of the dispersant each were added to a dye indicator solution (a weight ratio of a dye B to a dye A was 16:1; in this example, bromothymol blue was adopted as the dye B for example, and methyl red was adopted as the dye A for example; and in other examples, these two dyes could be replaced with other existing dyes) to prepare homogeneous dye solutions for coloring silica gel particles. The appearance and chromogenic effects of colored particles were observed by naked eyes and compared.

Evaluation criteria for qualification: An apparent color was uniform according to visual observation and could be clearly distinguished and identified after different pH buffer solutions were added.

TABLE 3
Concentrations and experimental results for the dispersant

| | Dispersant | Appearance |
|---|---|---|
| No. | concentration (wt. %) | and chromogenic effect |
| 1 | 2 | Unqualified |
| 2 | 5 | Qualified |
| 3 | 8 | Qualified |
| 4 | 11 | Qualified |
| 5 | 14 | Qualified |

### 2. Experimental Results

It can be seen from the results in Table 3 that the dispersant can meet the performance requirements of the product when at a mass percentage of 5% or more. From the perspective of cost saving, a mass percentage concentration of the dispersant is preferably controlled at 5%.

### Example 4

### 1. Experimental Method

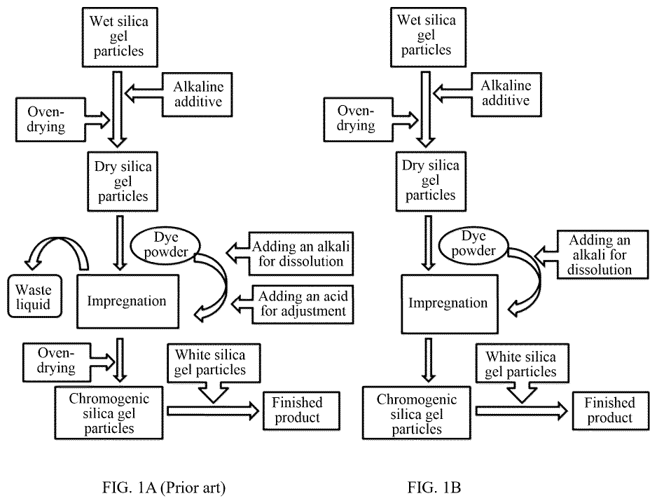

In this example, a preparation method of a color-changing pH-indicating silica gel was provided. 6 experimental groups were set according to the conditions in table 4 below. A flow chart was shown in FIG. 1B, and specific steps were as follows:

S1: An acidic additive was added to raw material silica gel particles for soaking, and a PH of the silica gel particles was kept at 3 to 7.

The acidic additive was aluminum nitrate, aluminum sulfate, or potassium aluminum sulfate. The soaking in the acidic additive was conducted under the following conditions: a soaking temperature: 20° C. to 90° C., a soaking time: 3 h to 24 h, and a soaking concentration: 0.01% to 1%.

S2: Wet silica gel particles produced after the treatment in the previous step were collected, dewatered and dried, and graded and screened according to a particle size of 0.5 mm to 2 mm to produce a silica gel raw material for dyeing.

The dewatering and drying was conducted at 80° C. to 150° C. for 4 h to 36 h.

S3: A PH-indicating dye solution was added to the silica gel particles, and thorough mixing was conducted, such that the dye solution evenly entered pores of the silica gel and was adsorbed by the silica gel particles to produce dyed silica gel particles with a moisture content kept at 15% to 50%, which were color-changing indicating silica gel particles.

A preparation method of the PH-indicating dye solution was as follows:

A dye A (one of methyl orange, bromocresol green, ethoxychrysoidine hydrochloride, methyl red, thymol blue, and quinaldine red) and a dye B (one of catechol violet, litmus, bromothymol blue, m-cresol purple, and α-naphtholbenzein) were mixed according to a weight ratio of 1/100 to ½ and dissolved in a sodium hydroxide solution, with a dye concentration of 0.05% to 1%. A dispersion additive (polyethylene glycol) was added with a volume percentage concentration of 7% to 50% to a dye solution produced after the dissolution, and thorough stirring was conducted to produce a dye solution for later use. In this example, a weight ratio of the dye B to the dye A was 16:1, a dye mass percentage concentration was 0.5%, and a mass percentage concentration of the dispersant was 5%, which were adopted for example.

S4: The color-changing indicating silica gel particles and an untreated raw material silica gel with a low moisture content were thoroughly mixed.

A moisture content of the raw material silica gel was 0.5% to 5%. A mixing mass ratio of the color-changing indicating silica gel particles to the untreated raw material silica gel with the low moisture content was 5% to 30%. A treating time was 12 h to 72 h.

Experimental steps for a control group: The raw material wet silica gel particles were soaked in an alkaline additive, dewatered and dried, and graded and screened according to a particle size of 0.5 mm to 2 mm to produce a silica gel raw material for dyeing. A dyeing treatment was conducted according to the dyeing method for the above six groups. Mixing with a low-moisture-content silica gel was conducted, and then testing was conducted.

TABLE 4
Experimental conditions for each experimental group

| | | | | | | Mixing |
|---|---|---|---|---|---|---|
| | | | | | | ratio of a |
| | | Soaking | | | | dyed silica |
| | | temperature, | | | | gel and a |
| | | time, and | | Dye A and | Moisture | raw |
| | | soaking | | dye B | content | material |
| | | concentration | Dewatering | adopted for a | in dyed | silica gel |
| | | of the | and drying | PH-indicating | silica gel | and treating |
| Group | Additive | additive | conditions | dye solution | particles | time |
| Experimental | Aluminum | 60° C., 6 h, | 150° C., 4 h | Ethoxychrysoidine | 15% | 30%, 24 h |
| group 1 | nitrate | 0.3% | | hydrochloride/ | | |
| | | | | bromothymol | | |
| | | | | blue | | |
| Experimental | Aluminum | 80° C., 4 h, | 80° C., 36 h | Ethoxychrysoidine | 35% | 13%, 48 h |
| group 2 | sulfate | 0.8% | | hydrochloride/ | | |
| | | | | bromothymol | | |
| | | | | blue | | |
| Experimental | Potassium | 40° C., 12 h, | 120° C., 12 h | Ethoxychrysoidine | 50% | 6%, 76 h |
| group 3 | aluminum | 0.5% | | hydrochloride/ | | |
| | sulfate | | | bromothymol | | |
| | | | | blue | | |
| Experimental | Aluminum | 30° C., 20 h, | 100° C., 15 h | Ethoxychrysoidine | 30% | 16%, 55 h |
| group 4 | nitrate/ | 0.4% | | hydrochloride/ | | |
| | aluminum | | | bromothymol | | |
| | sulfate = | | | blue | | |
| | 1/1 | | | | | |
| Experimental | Potassium | 55° C., 9 h, | 140° C., 8 h | Ethoxychrysoidine | 22% | 10%, 20 h |
| group 5 | aluminum | 0.7% | | hydrochloride/ | | |
| | sulfate/ | | | bromothymol | | |
| | aluminum | | | blue | | |
| | sulfate = | | | | | |
| | 2/1 | | | | | |
| Example 6 | Aluminum | 80° C., 4 h, | 80° C., 36 h | Methyl red/ | 35% | 13%, 48 h |
| | sulfate | 0.8% | | bromothymol | | |
| | | | | blue/thymol | | |
| | | | | blue | | |
| Control | Sodium | 60° C., 7 h | 140° C. 8 h | Ethoxychrysoidine | 43% | 8%, 28 h |
| group | hydroxide | 0.1% | | hydrochloride/ | | |
| | | | | bromothymol | | |
| | | | | blue | | |

### 2. Performance Testing Methods and Devices

Pore volume: BET detector.
Specific surface area: BET detector.
Raw material silica gel pH: acidity meter.
Dye-adsorption capacity: ICP-MS.
Appearance uniformity: color difference meter.
Color-development sensitivity at different pH values: Buffer solutions were added dropwise, and visual observation and comparison were conducted.

### 3. Experimental Results and Analysis

According to the results in Table 5, through the treatment with the acidic additive and other improvements for the method, the color-changing pH-indicating silica gel prepared by the method in this example had a significantly improved pore volume, specific surface area, dye-adsorption capacity, and color-development sensitivity, was acidic, and had uniform appearance.

TABLE 5
Performance test results for a color-changing indicating silica gel
in each experimental group

| | | | | | | Color- |
|---|---|---|---|---|---|---|
| | | Specific | | Dye- | | develop- |
| | Pore | surface | | adsorption | Color | ment |
| | volume | area | | capacity | difference | sensi- |
| Group | (mL/g) | (m²/g) | pH | (mg/kg) | uniformity | tivity |
| Experimental | 1.16 | 517 | 4.49 | 445 | 83% | Sensitive |
| group 1 | | | | | | |
| Experimental | 1.09 | 496 | 4.23 | 386 | 88% | Sensitive |
| group 2 | | | | | | |
| Experimental | 1.12 | 539 | 5.22 | 417 | 91% | Sensitive |
| group 3 | | | | | | |
| Experimental | 1.05 | 484 | 5.41 | 391 | 85% | Sensitive |
| group 4 | | | | | | |
| Experimental | 1.02 | 523 | 4.98 | 322 | 81% | Sensitive |
| group 5 | | | | | | |
| Experimental | 1.12 | 515 | 4.27 | 436 | 85% | Sensitive |
| group 6 | | | | | | |
| Control | 0.89 | 384 | 7.13 | 205 | 62% | In- |
| group | | | | | | sensitive |

It can be understood that a person of ordinary skill in the art can make equivalent substitutions or changes according to the technical solutions and inventive concepts of the present disclosure, and these substitutions or changes shall all fall within the protection scope of the claims of the present disclosure.

What is claimed is:

1. A preparation method of a color-changing pH-indicating silica gel, comprising the following steps:
S1, adding an acidic additive to silica gel particles for soaking, and keeping a PH of the silica gel particles at 3 to 7;
S2, collecting wet silica gel particles produced after a treatment in the S1, dewatering and drying, and grading and screening dried silica gel particles according to a particle size of 0.5 mm to 2 mm to produce a silica gel raw material for dyeing;
S3, adding a PH-indicating dye solution to the silica gel raw material, and thoroughly mixing, such that the PH-indicating dye solution evenly enters pores of the silica gel raw material and is adsorbed by the silica gel raw material to produce dyed silica gel particles with a moisture content kept at 15% to 50%, wherein the dyed silica gel particles are color-changing indicating silica gel particles; and
S4, thoroughly mixing the color-changing indicating silica gel particles and an untreated raw material silica gel with a low moisture content.

2. The preparation method of the color-changing pH-indicating silica gel according to claim 1, wherein a preparation method of the PH-indicating dye solution is as follows:
mixing a first dye and a second dye according to a weight ratio of 1/100 to 1/2, and dissolving in an alkaline solution with a dye mass percentage concentration of 0.05% to 1%;
and adding a dispersion additive with a volume percentage concentration of 5% to 50%, and thoroughly stirring to produce the PH-indicating dye solution,
wherein the first dye is methyl orange, bromocresol green, ethoxychrysoidine hydrochloride, methyl red, thymol blue, or quinaldine red; and the second dye is catechol violet, litmus, bromothymol blue, m-cresol purple, or α-naphtholbenzein.

3. The preparation method of the color-changing pH-indicating silica gel according to claim 2, wherein the dispersion additive is polyethylene glycol or polyvinylpyrrolidone.

4. The preparation method of the color-changing pH-indicating silica gel according to claim 1, wherein the acidic additive is selected from one or more of aluminum nitrate, aluminum sulfate, and potassium aluminum sulfate.

5. The preparation method of the color-changing pH-indicating silica gel according to claim 1, wherein the soaking in the acidic additive is conducted under the following conditions: a soaking temperature: 20° C. to 90° C., a soaking time: 3 h to 24 h, and a mass percentage concentration of the acidic additive: 0.01% to 1%.

6. The preparation method of the color-changing pH-indicating silica gel according to claim 1, wherein in the S2, the dewatering and drying is conducted at 80° C. to 150° C. for 4 h to 36 h.

7. The preparation method of the color-changing pH-indicating silica gel according to claim 1, wherein in the S3, an excessive dye solution on the silica gel raw material is removed through centrifugation.

8. The preparation method of the color-changing pH-indicating silica gel according to claim 1, wherein in the S4, the moisture content of the untreated raw material silica gel is 0.5% to 10%, and a mass ratio of the color-changing indicating silica gel particles to the untreated raw material silica gel with the low moisture content is 5% to 30%; and a treating time is 12 h to 76 h.

9. The preparation method of the color-changing pH-indicating silica gel according to claim 1, wherein the untreated raw material silica gel has a particle size of 0.5 mm to 4 mm, a pore volume of 0.7 mL/g to 1.1 mL/g, and a specific surface area of 300 m²/g to 600 m²/g.

10. A color-changing pH-indicating silica gel prepared by the preparation method according to claim 1.

11. The color-changing pH-indicating silica gel according to claim 10, wherein in the preparation method, a preparation method of the PH-indicating dye solution is as follows:
mixing a first dye and a second dye according to a weight ratio of 1/100 to 1/2, and dissolving in an alkaline solution with a dye mass percentage concentration of 0.05% to 1%; and
adding a dispersion additive with a volume percentage concentration of 5% to 50%, and thoroughly stirring to produce the PH-indicating dye solution,
wherein the first dye is methyl orange, bromocresol green, ethoxychrysoidine hydrochloride, methyl red, thymol blue, or quinaldine red; and the second dye is catechol violet, litmus, bromothymol blue, m-cresol purple, or α-naphtholbenzein.

12. The color-changing pH-indicating silica gel according to claim 11, wherein in the preparation method, the dispersion additive is polyethylene glycol or polyvinylpyrrolidone.

13. The color-changing pH-indicating silica gel according to claim 10, wherein in the preparation method, the acidic additive is selected from one or more of aluminum nitrate, aluminum sulfate, and potassium aluminum sulfate.

14. The color-changing pH-indicating silica gel according to claim 10, wherein in the preparation method, the soaking in the acidic additive is conducted under the following conditions: a soaking temperature: 20° C. to 90° C., a soaking time: 3 h to 24 h, and a mass percentage concentration of the acidic additive: 0.01% to 1%.

15. The color-changing pH-indicating silica gel according to claim 10, wherein in the S2 of the preparation method, the dewatering and drying is conducted at 80° C. to 150° C. for 4 h to 36 h.

16. The color-changing pH-indicating silica gel according to claim 10, wherein in the S3 of the preparation method, an excessive dye solution on the silica gel raw material is removed through centrifugation.

17. The color-changing pH-indicating silica gel according to claim 10, wherein in the S4 of the preparation method, the moisture content of the untreated raw material silica gel is 0.5% to 10%, and a mass ratio of the color-changing indicating silica gel particles to the untreated raw material silica gel with the low moisture content is 5% to 30%; and a treating time is 12 h to 76 h.

18. The color-changing pH-indicating silica gel according to claim 10, wherein in the preparation method, the untreated raw material silica gel has a particle size of 0.5 mm to 4 mm, a pore volume of 0.7 mL/g to 1.1 mL/g, and a specific surface area of 300 m²/g to 600 m²/g.
